(19) United States
(12) Patent Application Publication
(10) Pub. No.: US 2016/0019280 A1
(43) Pub. Date: Jan. 21, 2016

(54) IDENTIFYING QUESTION ANSWERERS IN A QUESTION ASKING SYSTEM

(71) Applicant: GOOGLE INC., Mountain View, CA (US)

(72) Inventors: Alexander Ketner Unger, San Francisco, CA (US); Frances Bordwell Haugen, Mountain View, CA (US)

(73) Assignee: GOOGLE INC., Mountain View, CA (US)

(21) Appl. No.: 13/842,570

(22) Filed: Mar. 15, 2013

(51) Int. Cl. G06F 17/30

(52) U.S. Cl. CPC G06F 17/30595

(57) ABSTRACT

Methods and systems are provided for a question answering. In some implementations, a question is received from a question asker. A complexity metric associated with the question is determined. One or more potential question answerers to answer the question are identified. For each of the one or more potential question answerers, a sophistication metric is determined. At least the sophistication metric and the complexity metric are analyzed to generate a metric analysis. A question answerer to answer the question is selected from the potential question answerers based at least in part on the metric analysis.

### BACKGROUND

This disclosure generally relates to computer-implemented techniques for selecting individuals for answering questions in a question answering system.

### SUMMARY

In some implementations, a system receives questions from users and provides the questions to human question answerers. The system may use one or more metrics to identify a question answerer. In some implementations, metrics include a sophistication metric, a willingness metric, a busyness metric, any other suitable metric, or any combination thereof.

In some implementations, a computer-implemented method is provided. The method includes receiving a question from a question asker. The method further includes identifying one or more potential question answerers to answer the question. The method further includes for each of the one or more potential question answerers, determining a sophistication metric. The method further includes analyzing the sophistication metric to generate a metric analysis. The method further includes selecting a question answerer to answer the question from the one or more potential question answerers based at least in part on the metric analysis.

These and other implementations can each include one or more of the following features. In some implementations, the method further includes providing the question to the selected question answerer, receiving a response from the selected question answerer, and providing an answer to the question asker based at least in part on the response. In some implementations of the method, identifying the one or more potential question answerers comprises identifying the one or more potential question answerers based at least in part on the question. In some implementations of the method, determining the complexity metric comprises determining a complexity metric based at least in part on linguistic characteristics of the question. In some implementations of the method, determining the complexity metric comprises determining the complexity metric based at least in part on a sophistication metric associated with the question asker. In some implementations of the method, determining the sophistication metric comprises determining the sophistication metric based at least in part prior question answering interactions of a respective potential question answerer. In some implementations of the method, determining the sophistication metric comprises determining the sophistication metric based at least in part on prior search activity of a respective potential question answerer. In some implementations of the method, determining the sophistication metric comprises determining the sophistication metric based at least in part on a knowledge level of a respective potential question answerer in a subject area relevant to the question. In some implementations of the method, identifying one or more potential question answerers comprises identifying the potential question answerers from a social graph. In some implementations, the method further includes, for each of the one or more potential question answerers, determining a busyness metric associated with the respective potential question answerer, wherein the metric analysis is further generated based on an analysis the sophistication metric. In some implementations, the method further includes, for each of the one or more potential question answerers, determining a willingness metric associated with the respective potential question answerer, wherein the metric analysis is further generated based on an analysis of the willingness metric.

In some implementations, a system including one or more computers configured to perform operations is provided. The operations include receiving a question from a question asker. The operations further include identifying one or more potential question answerers to answer the question. The operations further include for each of the one or more potential question answerers, determining a sophistication metric. The operations further include analyzing the sophistication metric to generate a metric analysis. The operations further include selecting a question answerer to answer the question from the one or more potential question answerers based at least in part on the metric analysis.

These and other implementations can each include one or more of the following features. In some implementations of the system, the one or more computers are configured to perform operations further including providing the question to the selected question answerer, receiving a response from the selected question answerer, and providing an answer to the question asker based at least in part on the response. In some implementations of the system, determining the complexity metric comprises determining a complexity metric based at least in part on linguistic characteristics of the question. In some implementations of the system, determining the complexity metric comprises determining the complexity metric based at least in part on a sophistication metric associated with the question asker. In some implementations of the system, determining the sophistication metric comprises determining the sophistication metric based at least in part prior question answering interactions of a respective potential question answerer. In some implementations of the system, determining the sophistication metric comprises determining the sophistication metric based at least in part on prior search activity of a respective potential question answerer. In some implementations of the system, determining the sophistication metric comprises determining the sophistication metric based at least in part on a knowledge level of a respective potential question answerer in a subject area relevant to the question. In some implementations of the system, identifying one or more potential question answerers comprises identifying the potential question answerers from a social graph. In some implementations of the system, the one or more computers are configured to perform operations further includes, for each of the one or more potential question answerers, determining a busyness metric associated with the respective potential question answerer, wherein the metric analysis is further generated based on an analysis the busyness metric. In some implementations of the system, the one or more computers are configured to perform operations further including, for each of the one or more potential question answerers, determining a willingness metric associated with the respective potential question answerer, wherein the metric analysis is further generated based on an analysis of the willingness metric.

In some implementations, a computer-implemented method is provided. The method includes receiving a question from a question asker. The method further includes identifying one or more potential question answerers to answer the question. The method further includes for each of the one or more potential question answerers, determining a willingness metric based at least in part on prior social interactions of the respective potential question answerer. The method further includes analyzing the willingness metric to generate a metric analysis. The method further includes selecting a question answerer to answer the question from the one or more potential question answerers based at least in part on the metric analysis.

These and other implementations can each include one or more of the following features. In some implementations, the method further includes providing the question to the selected question answerer, receiving a response from the selected question answerer, and providing an answer to the question asker based at least in part on the response. In some implementations, identifying the one or more potential question answerers is based at least in part on the question. In some implementations, determining the willingness metric is based at least in part on a frequency of social interactions of a respective potential question answerer. In some implementations, determining the willingness metric is based at least in part on a degree of social connectivity associated with social interactions of a respective potential question answerer. In some implementations, determining the willingness metric is based at least in part on a personal attribute of a respective potential question answerer. In some implementations, determining the willingness metric is based at least in part on preferences set by a respective potential question answerer. In some implementations, identifying one or more potential question answerers includes identifying the potential question answerers in a social graph. In some implementations, determining the willingness metric is based at least in part on a rating of a respective potential question answerer, wherein the rating is based at least in part on ratings received from previous question askers, wherein the rating corresponds to the quality of one or more previous interactions. In some implementations, the method further includes, for each of the one or more potential question answerers, determining a sophistication metric associated with the respective potential question answerer, wherein the metric analysis is further generated based on an analysis the sophistication metric. In some implementations, the method further includes, for each of the one or more potential question answerers, determining a busyness metric associated with the respective potential question answerer, wherein the metric analysis is further generated based on an analysis of the busyness metric.

In some implementations, a system including one or more computers configured to perform operations is provided. The operations include receiving a question from a question asker. The operations further include identifying one or more potential question answerers to answer the question. The operations further include for each of the one or more potential question answerers, determining a willingness metric based at least in part on prior social interactions of the respective potential question answerer. The operations further include analyzing the willingness metric to generate a metric analysis. The operations further include selecting a question answerer to answer the question from the one or more potential question answerers based at least in part on the metric analysis.

These and other implementations can each include one or more of the following features. In some implementations of the system, the one or more computers are configured to perform operations further including providing the question to the selected question answerer, receiving a response from the selected question answerer, and providing an answer to the question asker based at least in part on the response. In some implementations of the system, identifying the one or more potential question answerers is based at least in part on the question. In some implementations of the system, determining the willingness metric is based at least in part on a frequency of social interactions of a respective potential question answerer. In some implementations of the system, determining the willingness metric is based at least in part on a degree of social connectivity associated with social interactions of a respective potential question answerer. In some implementations of the system, determining the willingness metric is based at least in part on a personal attribute of a respective potential question answerer. In some implementations of the system, determining the willingness metric is based at least in part on preferences set by a respective potential question answerer. In some implementations of the system, identifying one or more potential question answerers includes identifying the potential question answerers in a social graph. In some implementations of the system, determining the willingness metric is based at least in part on a rating of a respective potential question answerer, wherein the rating is based at least in part on ratings received from previous question askers, wherein the rating corresponds to the quality of one or more previous interactions. In some implementations of the system, the one or more computers are configured to perform operations further includes, for each of the one or more potential question answerers, determining a sophistication metric associated with the respective potential question answerer, wherein the metric analysis is further generated based on an analysis the sophistication metric. In some implementations of the system, the one or more computers are configured to perform operations further including, for each of the one or more potential question answerers, determining a busyness metric associated with the respective potential question answerer, wherein the metric analysis is further generated based on an analysis of the busyness metric.

In some implementations, a computer-implemented method is provided. The method includes receiving a question from a question asker. The method further includes identifying one or more potential question answerers to answer the question. The method further includes for each of the one or more potential question answerers, determining a busyness metric based at least in part on activity of the respective potential question answerers. The method further includes analyzing the busyness metric to generate a metric analysis. The method further includes selecting a question answerer to answer the question from the one or more potential question answerers based at least in part on the metric analysis.

These and other implementations can each include one or more of the following features. In some implementations, the method further includes providing the question to the selected question answerer, receiving a response from the selected question answerer, and providing an answer to the question asker based at least in part on the response. In some implementations of the method, identifying the one or more potential question answerers comprises identifying the one or more potential question answerers based at least in part on the question. In some implementations of the method, determining the busyness metric comprises determining the busyness metric based at least in part on geographical information of a respective potential question answerer. In some implementations of the method, determining the busyness metric comprises determining the busyness metric based at least in part on the type of activity of a respective potential question answerer at that time. In some implementations of the method, determining the busyness metric comprises determining the busyness metric based at least in part on chronological information. In some implementations of the method, determining the busyness metric comprises determining the busyness metric based at least in part on an amount of activity of a respective potential question answerer. In some implementations of the method, determining the busyness metric comprises determining the busyness metric based at least in part on an indication of availability received from a respective potential question answerer. In some implementations of the method, identifying one or more potential question answerers comprises identifying the potential question answerers from a social graph. In some implementations, the method further includes, for each of the one or more potential question answerers, determining a sophistication metric associated with the respective potential question answerer, wherein the metric analysis is further generated based on an analysis the sophistication metric. In some implementations, the method further includes, for each of the one or more potential question answerers, determining a willingness metric associated with the respective potential question answerer, wherein the metric analysis is further generated based on an analysis of the willingness metric.

In some implementations, a system including one or more computers configured to perform operations is provided. The operations include receiving a question from a question asker. The operations further include identifying one or more potential question answerers to answer the question. The operations further include for each of the one or more potential question answerers, determining a busyness metric based at least in part on activity of the respective potential question answerers. The operations further include analyzing the busyness metric to generate a metric analysis. The operations further include selecting a question answerer to answer the question from the one or more potential question answerers based at least in part on the metric analysis.

These and other implementations can each include one or more of the following features. In some implementations of the system, the one or more computers are configured to perform operations further including providing the question to the selected question answerer, receiving a response from the selected question answerer, and providing an answer to the question asker based at least in part on the response. In some implementations of the system, identifying the one or more potential question answerers comprises identifying the one or more potential question answerers based at least in part on the question. In some implementations of the system, determining the busyness metric comprises determining the busyness metric based at least in part on geographical information of a respective potential question answerer. In some implementations of the system, determining the busyness metric comprises determining the busyness metric based at least in part on the type of activity of a respective potential question answerer at that time. In some implementations of the system, determining the busyness metric comprises determining the busyness metric based at least in part on chronological information. In some implementations of the system, determining the busyness metric comprises determining the busyness metric based at least in part on an amount of activity of a respective potential question answerer. In some implementations of the system, determining the busyness metric comprises determining the busyness metric based at least in part on an indication of availability received from a respective potential question answerer. In some implementations of the system, identifying one or more potential question answerers comprises identifying the potential question answerers from a social graph.

In some implementations of the system, the one or more computers are configured to perform operations further includes, for each of the one or more potential question answerers, determining a sophistication metric associated with the respective potential question answerer, wherein the metric analysis is further generated based on an analysis the sophistication metric. In some implementations of the system, the one or more computers are configured to perform operations further including, for each of the one or more potential question answerers, determining a willingness metric associated with the respective potential question answerer, wherein the metric analysis is further generated based on an analysis of the willingness metric.

### BRIEF DESCRIPTION OF THE FIGURES

FIG. 1 is a high level block diagram of a system for using metrics in a question answering system in accordance with some implementations of the present disclosure;

FIG. 2 shows an exemplary user interface sequence for using metrics in a question answering system in accordance with some implementations of the present disclosure;

FIG. 3 shows a flow diagram of illustrative steps for using metrics in a question answering system in accordance with some implementations of the present disclosure;

FIG. 4 shows exemplary data used in determining a sophistication metric in accordance with some implementations of the present disclosure;

FIG. 5 shows exemplary data used in determining a willingness metric in accordance with some implementations of the present disclosure;

FIG. 6 shows exemplary data used in determining a busyness metric in accordance with some implementations of the present disclosure;

FIG. 7 shows an illustrative computer system in accordance with some implementations of the present disclosure; and

FIG. 8 is a block diagram of a computer in accordance with some implementations of the present disclosure.

### DETAILED DESCRIPTION OF THE FIGURES

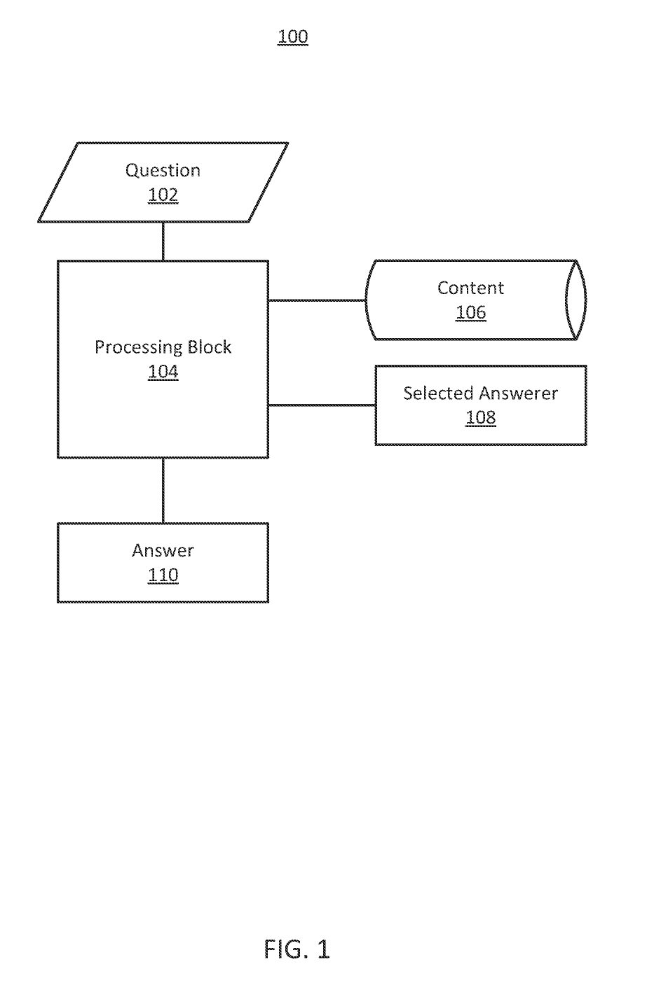

FIG. 1 is a high level block diagram of a system for using metrics in a question answering system in accordance with some implementations of the present disclosure. System 100 includes question 102, processing block 104, content block 106, selected answerer block 108, and answer block 110. System 100 may include any suitable hardware, software, or both for implementing the features described in the present disclosure and will generally be referred to, herein, as “the system.”

In some implementations, the system receives a question from a user and provides the question to another user for answering. As used herein, a user may be a question asker, a question answerer, or any other suitable user. It will be understood that while the system is described in relation to an interaction between a question asker and a question answerer, either of both of the question asker and question answerer may be one or more people, one or more applications, one or more groups, any other suitable source of questions and/or answers, or any combination thereof. In an example, the system receives a question from a human user and provides the question for answering to a human question answerer. In another example, the system provides computer-generated questions to human question answerers. In another example, a question from one question asker may be provided to multiple question answerers. In another example, questions may be answered by a computer.

The system may use one or more metrics to select a question answerer from one or more potential question answerers. Multiple metrics may be combined using any suitable technique, for example, a weighted average. In some implementations, metrics include a sophistication metric, a complexity metric, a willingness metric, and a busyness metric. Metrics may be predetermined, determined at the time of question asking, determined at any other suitable time, or any combination thereof. In some implementations, predetermined parameters may be determined on a periodic basis, may be determined based on the occurrence of a triggering event such as a question being answered, may be determined as part of a system initialization or design process, may be determined at any other suitable time, or any combination thereof. In an example, the system may determine metrics for a potential question answerer when they answer a question, and the system may use those metrics to select a potential question answerer for a subsequently asked question.

A sophistication metric is based on a question answerer's abilities related to answering questions. Sophistication may take into account a question answerer's knowledge level, a question answerer's search skills, a user's expertise in a particular subject area, any other suitable information, or any combination thereof.

A level of complexity metric is based on an expected difficulty involved in answering a particular question. Complexity may take into account a sophistication metric associated with the question asker, the length of the question, the length of words in the query, the complexity of words used the query, previous times the same or similar questions have been asked, user input, other suitable determinations, and any combination thereof.

A willingness metric is based on an expected willingness of a question answerer to answer a particular question. In some implementations, a willingness metric takes into account a user's frequency and/or type of prior social interactions. In some implementations, a willingness metric takes into account personal attributes of a user, such as search history. Personal attributes may include any suitable attributes that a user has elected to provide to the system. Personal attributes may include, for example, search history, age, gender, geographic location, time zone, level of education, social connections, use of social networking websites. Willingness metrics may also be based on a degree of social connection associated with prior interactions. For example, a user that has previously had many online interactions with strangers may be expected to be more willing to answer a question from a stranger than a question answerer that mostly interacts online with friends and family.

Maliciously poor question answerers, sometimes referred to as trolls, pose a problem for the system in that they tend to be willing to interact but will provide unwanted or undesirable answers. In some implementations, a feedback system using ratings from previous question askers is used to reduce the likelihood of poor interactions. In some implementations, this feedback system may be used to lower the willingness metric of a suspected troll. In some implementations, the feedback system or any other suitable technique for identifying trolls and/or other undesirable question answerers may be used to remove these individuals separate from the willingness metric.

A busyness metric is based on the availability of a user. The busyness metric may be based on information that a user has elected to provide to the system. For example, a busyness metric may be indicative of how actively engaged in computer activities a user is at the time of selecting a question answerer. This may be indicative of how intrusive or unwanted a question might be at that time. For example, the system may assign a user that is browsing a social media site or reading the summary page of an online newspaper a low busyness metric, and accordingly infer that they are available to answer questions. In another example, the system may assign to a user that is working on an online document, composing an email, or reading a multipage news article a high busyness metric, and accordingly infer that the user is not available to answer questions. In some implementations, providing questions to relatively less busy question answerers may result in faster response times and a more desirable experience for the question asker and for the question answerer.

The metrics described herein may be determined for question askers, for question answerers, for questions, for any other suitable elements of the system, and any combination thereof. In an example, the system determines a busyness metric for a potential question answerer. In another example, the system determines a complexity metric for a question and a willingness metric for a potential question answerer. In another example, a sophistication metric may be determined for both a question asker and a question answerer.

In some implementations, processing block 104 receives question 102 and selects a question answerer based on content in content block 106. Processing block 104 provides question 102 to selected question answerer block 108 and receives a response from selected question answerer block 108. Processing block 104 provides an answer in answer block 110 based on the response from selected question answerer block 108.

In some implementations, question 102 includes a question received from a question asker. In an example, a question asker is a person with a question for which they desire a human answer. For example, the question may be complex or involve opinion in such a way that a person answering the question would be desirable. In some implementations, Question 102 is received as text, voice, an image, a video, any other suitable content, or any combination thereof. For example, the system may receive the text question [What is the best sushi restaurant in San Diego]. In another example, the system may receive a voice question including similar content. The audio may be converted to text, may be maintained as audio, or both. In an example, the system uses text from voice-to-text conversion to identify a selected question answerer, and provides the question to the question answerer as audio.

In some implementations, the system uses natural language processing. For example, the system may use natural language processing to process question 102. As used herein, natural language refers to words, syntax, and other language such as it could be used in conversation or prose. For example, natural language may include complete sentences, questions, idiom, punctuation, any other suitable language elements or structures, or any combination thereof. For example, the question [Who was the first person to fly an airplane?] is a natural language question. In contrast, formal language follows relatively more constrained rules of grammar and syntax. An example of formal language is a computer programming language such as C or BASIC. It will be understood that queries, including natural language queries, may be in any suitable language such as English, French, Chinese, and so on. It will be understood that in some implementations, the system need not receive a natural language query and may receive a query in any suitable form. It will also be understood that the system may receive questions, provide questions for answering, receive responses, provide answers, and perform any other suitable steps using natural language, formal language, keywords, voice, video, images, any other suitable communication technique, or any combination thereof.

In some implementations, content block 106 includes data organized in a graph. A graph is a data structure containing nodes connected by edges. In some implementations, the data may include statements about relationships between things and concepts, and those statements may be represented as nodes and edges of a graph. The nodes each contain a piece or pieces of data and the edges represent relationships between the data contained in the nodes that the edges connect. In some implementations, the graph includes one or more pairs of nodes connected by an edge. The edge, and thus the graph, may be directed, i.e. unidirectional, undirected, i.e. bidirectional, or both, i.e. one or more edges may be undirected and one or more edges may be directional in the same graph. Nodes may include any suitable data or data representation. Edges may describe any suitable relationships between the data. In some implementations, an edge is labeled or annotated, such that it includes both the connection between the nodes, and descriptive information about that connection. A particular node may be connected by distinct edges to one or more other nodes, or to itself, such that an extended graph is formed. In some implementations, a social graph is a graph containing information related to people, connections between those people, and other suitable information.

In some implementations, content block 106 includes a social graph that contains question answerers. A social graph may be a data graph corresponding in part to people. The social graph may include a collection of people, connections between people and associated attributes, and connections between people. In some implementations, attributes include areas of knowledge about which a question answerer is familiar, sophistication, willingness, and busyness metrics, information that can be used to determine metrics, any other suitable information, or any combination thereof. It will be understood that potential question answerers need not be organized in a graph and may be stored in any suitable form such as a list, database, or index.

In some implementations, content block 106 includes a knowledge graph. In some implementations, a knowledge graph includes data organized in a graph. The data of a knowledge graph may include statements about relationships between entities, and those statements may be represented as nodes and edges of a graph. An entity may be a thing or concept that is singular, unique, well-defined, and distinguishable. For example, an entity may be a person, place, item, idea, topic, abstract concept, concrete element, other suitable thing, or any combination thereof. The nodes of a knowledge graph may each correspond to an entity, and the edges may represent relationships between the entities. In some implementations, a social graph may relate to a knowledge graph. For example, the social graph may include references to entities in the knowledge graph associated with a person in the social graph. In some implementations, questions answered by the system may correspond to entities in the knowledge graph.

In some implementations, content block 106 includes other suitable information in addition to potential question answerers. Content block 106 may include indexes associated with webpages on the Internet, documents, images, videos, audio, previously answered questions, indexes of previously answered questions, any other suitable content, or any combination thereof. In an example, processing block 104 uses indexes of previously answered questions stored in content block 106 to automatically identify an answer to question 102. In another example, processing block 104 may use statistical content related to question answerers stored in content block 106 in determining metrics associated with potential question answerers.

In some implementations, selected answerer block 108 includes a answerer selected by processing block 104 to answer the question. In an example, the system provides question 102 to the selected answerer of selected answerer block 108 by displaying the question on the display screen of a user device. In another example, the system may send an email or other electronic message to the selected answerer.

In some implementations, processing block 104 receives a response from selected answerer block 108, where the response is a response to question 102.

In some implementations, processing block 104 provides an answer to answer block 110 based on the response received from selected answerer block 108. For example, the answer may be the unaltered text of the received response. In another example, where the response is a voice message, the answer may be a text transcription using text-to-speech. In another example, the answer may include additional text, images, audio, or other content. In an example, the question may be [Who is the first US president] and the response from the question answerer is [George Washington], the answer may be [George Washington was the First US president]. The answer may also, for example, include a picture and a hyperlink to further information.

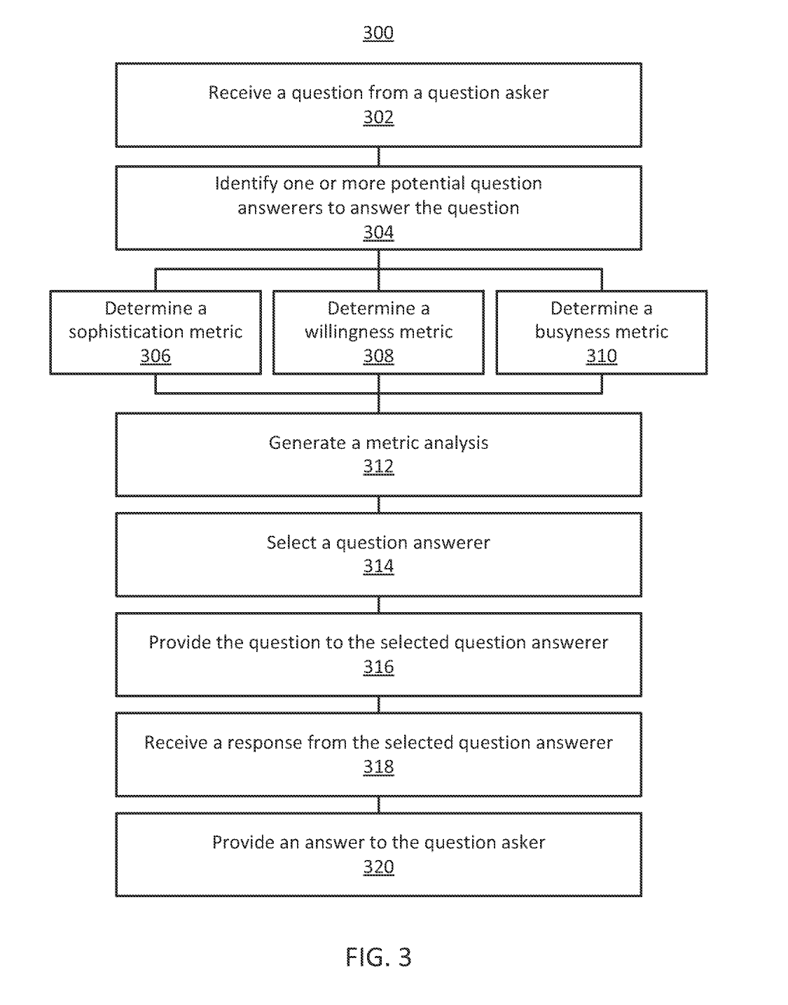

The techniques of system 100 are described in detail below in relation to flow diagram 300 of FIG. 3.

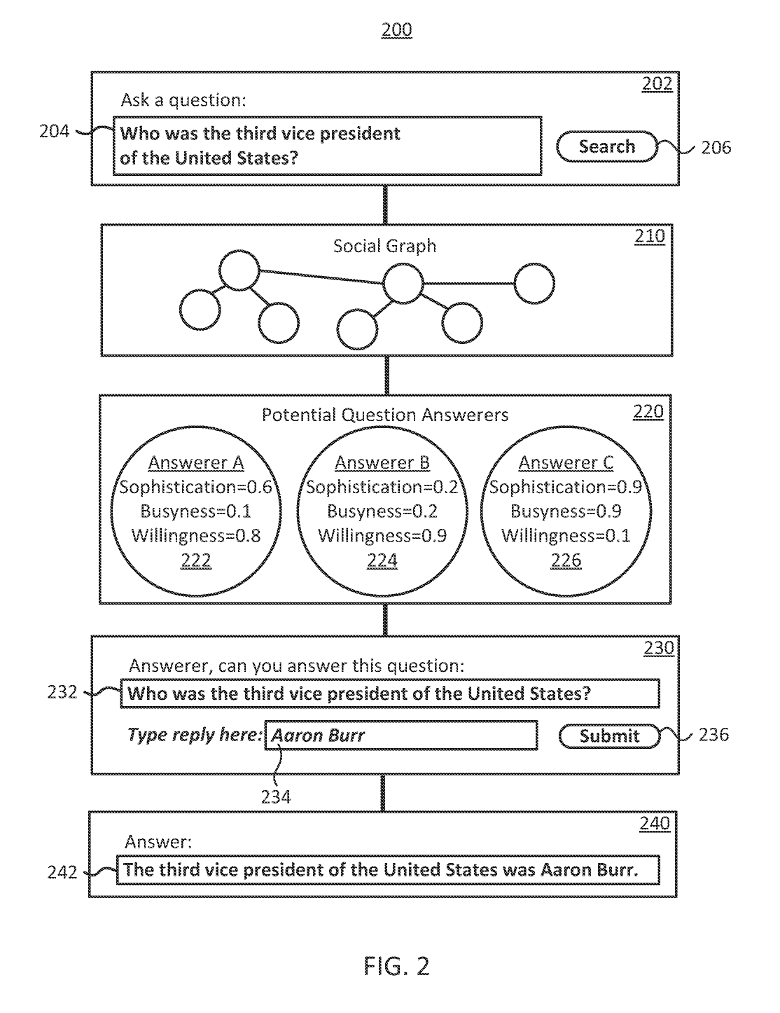

FIG. 2 shows exemplary user interface sequence 200 for using metrics in a question answering system in accordance with some implementations of the present disclosure. Sequence 200 includes question asking block 202, social graph 210, potential question answerers block 220, question answering block 230, and answer providing block 240. It will be understood that the illustrations of sequence 200 are merely exemplary and that any suitable interface may be used. Further, it will be understood that the illustrations may be visible to the question asker, the question answerer, neither the asker nor the answerer, any other suitable user, or any combination thereof. It will also be understood that in some implementations, a visual user interface need not be used, such as in a voice-based system.

Question asking block 202 illustrates receiving a question from a question asker. In some implementations, the question may correspond to question 102 of FIG. 1. In some implementations, the content of question asking block 202 is displayed to the question asker. The system displays a text entry box 204. The question asker may enter the question [Who was the third vice president of the United States?] in text entry box 204. The question may be entered using a keyboard, keypad, voice input, touchscreen input, any other suitable input, or any combination thereof. In some implementations, the question may be received from another application. For example, a question may be input based on a selection of text or other content on a webpage.

In some implementations, question asking block 202 may include search button 206. In some implementations, search button 206 receives user input indicating a question has been entered into text entry box 204. The search button may be activated, for example, using input received using a mouse, touchpad, keyboard, any other suitable input device, or any combination thereof.

Social graph block 210 illustrates a collection of question answerers from which potential question answerers may be selected. In some implementations, social graph block 210 corresponds to content block 106 of FIG. 1. In some implementations, the contents of social graph block 210 are not displayed to a user, but rather are representative of a process used by the system. It will be understood that in some implementations, all of the collection of question answerers in social graph block 210 may be considered as potential question answerers. It will also be understood that the use of a social graph is merely exemplary and that the collection of question answerers may be maintained as a list, index, database, data graph, any other suitable data structure, or any combination thereof.

In some implementations, the system identifies potential question answerers from social graph block 210 and provides the identified potential question answerers to potential question answerers block 220. In some implementations, the system identifies potential question answerers based on the question received in text entry box 204. For example, the system may analyze the question to identify a subject area. The system may identify a node in the social graph related to that subject area, and identify potential question answerers based on their connection to that node. In another example, the system uses known social connections between users such only that a question asker's friends and friends-of-friends are identified as potential question answerers. It will be understood that the aforementioned techniques for identifying potential question answerers are merely exemplary and that the system may use any suitable technique to identify potential question answerers from a social graph or from any other source. For example, the system may use techniques for identifying potential question answerers including random selection, a degree of social connections, subject area knowledge, other parameters stored in the social graph, any other suitable information, and any combination thereof.

Potential question answerers block 220 illustrates selection of question answerer based on one or more metrics. In some implementations, the system does not display the contents of potential question answerers block 220 to a user, but rather the contents are representative of a process used by the system. In some implementations, potential question answerers block 220 includes potential question answerers identified in social graph block 210. In the illustrated example, the system has identified three potential question answerers, answerer A 222, answerer B 224, and answerer C 226. The system determines a sophistication metric, a busyness metric, and a willingness metric for each of the identified potential answerers as shown. These metrics may be predetermined, may be determined based on the question, may be determined using any other suitable technique, or any combination thereof. Metrics in the illustrated example are shown on a scale of 0-1, although it will be understood that metrics may be determined and represented in any suitable way. In some implementations, the system selects one of the potential question answerers based on one or more of the metrics. For example, the metrics may be combined in some suitable way such as a sum, a weighted average, a more complex algorithm, any other suitable technique, or any combination thereof. In the illustrated example, Answerer A may be selected over Answerer C because of Answerer A's high willingness and low busyness metrics, despite Answerer C's higher sophistication metric. In another example, a complexity metric associated with the question may be used to determine that the question is relatively easy, and accordingly the system may select Answerer B. In this way, Answerer B may be assigned relatively easy questions, Answerer A may be assigned relatively more difficult question.

Question answering block 230 illustrates providing the question to a selected question answerer. In some implementations, the content of question answering block 230 is displayed to the question answerer selected by the system in potential question answerers block 220. In the illustrated example, the question [Who was the third vice president of the United States] is shown in question box 232. In some implementations, the text shown in question box 232 is the text received in text entry box 204. In some implementations, the text may be reordered, augmented, reduced, or otherwise altered. In an example, where the received question included the words [Who was the third vice president of the US], the system may replace the term [US] with [United States]. In another example, the system may correct spelling in the received question using any suitable spelling correction technique. In another example, where the original received question been [Who was the third vice president], the system add the words [of the United States] based on the geographic location of the question asker, based on the popularity of that question or related questions, based on clarification provided by the question asker, based on any other suitable information, or any combination thereof. In another example, the system adds content to question box 232 based on voice input received from the question asker. In another example, question box 232 displays a question that has been translated from another language.

In some implementations, response entry box 234 receives input from the question answerer. As described above for text entry box 204, a question answerer enters content into response entry box 234 using a keyboard, using voice entry, using a touchscreen, using content from another application for example by cut-and-paste, using any other suitable technique, or any combination thereof. In the illustrated example, the selected question answerer enters the text [Aaron Burr] into response entry box 234. In some implementations, submit button 236 receives input indicating that the question answerer has entered a response in response entry box 234. In some implementations, submit button 236 is configured as described above for search button 206.

In some implementations, answer providing block 240 illustrates providing an answer to the question received in question asking block 202 based on information the system receives in question answering block 230. In some implementations, the content of answer providing block 240 is displayed to the question asker. Answer providing block 240 includes question answer box 242 including the text [The third vice president of the United States was Aaron Burr.]. In some implementations, the system generates the text or other content of question answer box 242 based on the content received in question asking block 202, the response received in question answering block 230, any other suitable information, or any combination thereof. In the illustrated example, the answer provided in question answer box 242 is based on the question text [Who was the third vice president of the United States] and the response [Aaron Burr] received in response entry box 232. The system generates the natural language response shown in question answer box 242: [The third vice president of the United States was Aaron Burr]. In some implementations, natural language processing is used to generate a natural language response provided in question answer box 242. In another example, the response the system receives from the question answerer is displayed in question answer box 242 without alteration.

In some implementations, content provided in answer providing block 240, additionally or alternatively, includes information such as documents, links, images, video, audio, and other content that the system identifies based on the response received from the question answerer. In the illustrated example, the system may retrieve an image of Aaron Burr to be displayed along with the response in answer providing block 240 based on the received text [Aaron Burr] in response entry box 234.

FIG. 3 shows a flow diagram of illustrative steps for using metrics in a question answering system in accordance with some implementations of the present disclosure.

In step 302, the system receives a question from a question asker. In some implementations, the received question is question 102 of FIG. 1, the question received in question asking block 202 of FIG. 2, any other suitable question, or any combination thereof. In some implementations, the question is received as a text, audio, video, in any other suitable format, or any combination thereof. For example, the system may receive a text string including a question. In another example, the system may receive an audio clip including the question asker asking the question. In some implementations, the audio clip may be transcribed to text using voice recognition. Additionally or alternatively, the audio clip of the question may be provided to the question answerer, identified below. For example, a transcription may be used to identify a question answerer, and the answerer may be provided the audio clip. In some implementations, the system may receive the question using a smartphone, a desktop, a laptop, a tablet, a voice telephone, any other suitable user device, or any combination thereof. In some implementations, the user device may use a dedicated question answering application, an internet browser, an email system, a text messaging system, a voice system, any other suitable application, or any combination thereof.

In some implementations, the system compares the question received in step 302 to a database of previously answered questions. In some implementations, if the question has been previously answered, the system may provide the previously identified answer additionally or alternatively to performing the subsequent steps of flow diagram 300. In some implementations, the previously identified answer may be displayed based in part on a ranking or other feedback associated with the answer. For example, the system has received feedback indicating that the answer is likely to be incorrect, it may not display the previously identified answer and may proceed with the questions answering process. In another example, the system may provide the answer to the question asker, and query the asker if that answer is satisfactory and/or correct.

In step 304, the system identifies one or more potential question answerers. In some implementations, potential question answerers are identified to answer the question received in question 302. In some implementations, potential question answerers are identified from a social graph, for example, as described for social graph block 210 of FIG. 2, from content block 106 of FIG. 1, from any other suitable source, or any combination thereof.

As described above, in some implementations a social graph includes information describing relationships among users. In some implementations, a social graph also describes relationships between a user and a particular subject area, a characteristic of that user, other suitable information, and any combination thereof. For example, a graph may include a node for the topic [Dog Breeds], and that topic may be linked to users that are associated with the topic [Dog Breeds].

In some implementations, users add themselves to collection of question answerers from which the potential question answerers are identified in step 304. In some implementations, this includes selecting an amount of information to share with the system. For example, a user may elect to share information related to current computer activities, search history, browser history, social interaction history, any other suitable information, or any combination thereof. In some implementations, the shared information is used to determine the metrics described below.

In the following steps 306, 308, and 310, metrics are determined. In some implementations, one or more metrics are determined for each potential question answerer. For example, any one or more of the sophistication metric, the willingness metric, the busyness metric, and other suitable metrics are determined for each potential question answerer. In an example, the system only determines a willingness metric. In another example, the system determines a sophistication metric and a busyness metric. In another example, all three metrics are determined. In another example, a willingness metric and another metric not shown are determined.

In some implementations, one or more metrics may apply to multiple question answerers, for example, a group of potential question answerers may be assigned a common metric. In some implementations, metrics may be determined after identifying the question answerers. In some implementations, metrics may be refined based on previous values, adjusted based on the question or other suitable information, retrieved from stored data without modification, determined using any other suitable technique, or any combination thereof.

In some implementations, the metrics are a numerical representation of the characteristic they represent. The numerical representation may be on any suitable scale. In the example illustrated in FIG. 2, metrics are on a scale between 0 and 1. In another example, metrics may be on a scale between −1 and 1, 0 and 100, any other suitable scale, or any combination thereof. In another example, a metric may be a value greater than zero where the upper limit of the range is not defined.

It will be understood that metrics may be predetermined, determined at the time of selecting a question answerer, modified from previously determined values, determined in any other suitable technique, or any combination thereof. In some implementations, values are modified based on the question, based on the time of day, based on any other suitable information, or any combination thereof. For example, a sophistication metric describing a question answerer's familiarity with a particular subject area may be predetermined. In some implementations, predetermined parameters may be determined on a periodic basis, may be determined based on the occurrence of a triggering event such as a question being answered, may be determined as part of a system initialization or design process, may be determined at any other suitable time, or any combination thereof. In another example, a willingness metric may be determined at the time of selecting a question answerer based on a degree of social connection between a question asker and a potential question answerer. In another example, a sophistication metric may be determined at the time of selecting a question answerer by adjusting predetermined information associated with question answerers based on the text of the question.

In step 306, the system determines a sophistication metric. In some implementations, a sophistication metric is determined for each of the potential question answerers identified in step 304. As described above, sophistication relates to a determination of question answerer's abilities. In some implementations, the sophistication metric is a numerical representation of a determination of those abilities. For example, a highly sophisticated question answerer may be assigned a high sophistication metric while a less sophisticated question answerer may be assigned a lower sophistication metric.

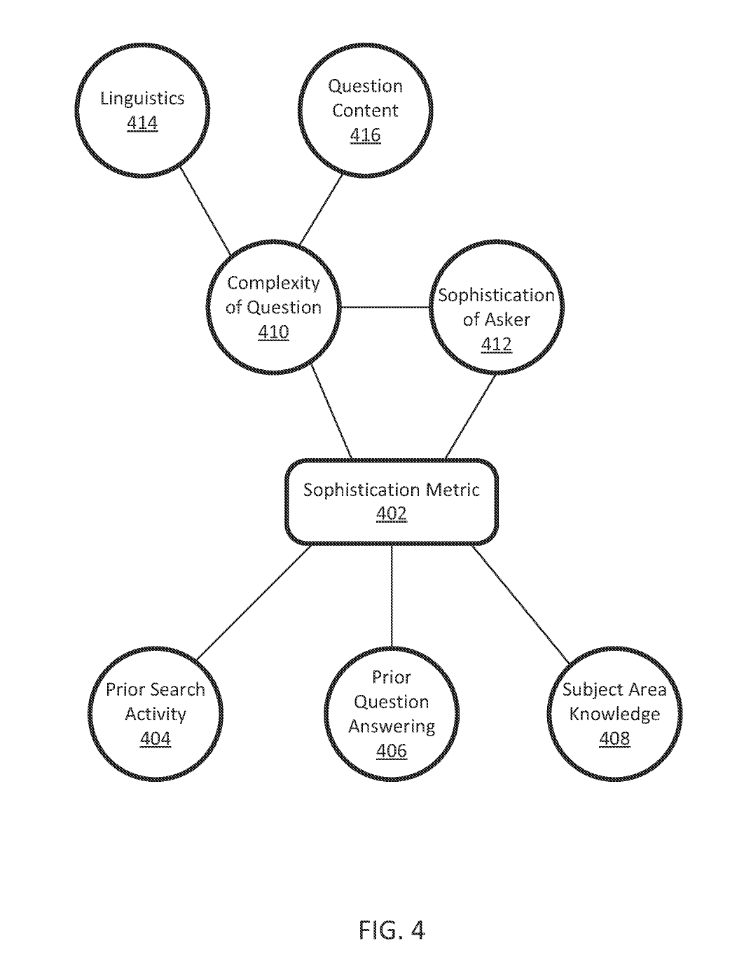

FIG. 4 shows exemplary data used in determining sophistication metric 402 in accordance with some implementations of the present disclosure. In some implementations, sophistication metric 402 corresponds to the sophistication metric determined in step 306 of FIG. 3. In some implementations, As illustrated, one or more data elements are used to determine sophistication metric 402.

In some implementations, the sophistication metric is based in part on prior search interactions activity 404. For example, the system may analyze previous Internet search engine searches performed by the user. In some implementations, searches may be analyzed based on the length of the searches, other linguistic characteristics of the searches, the content of the searches, the number of search results, refinements made to the search, the use of advanced search techniques such as search fields, date restrictions, and Boolean operators, any other suitable characteristics, and any combination thereof. For example, if a user routinely performs Internet searches with long and/or complex queries, that person may be assigned a high sophistication metric. In another example, a user that uses short search queries and/or queries with short words may be assigned a low sophistication metric. In another example, the system determines a sophistication metric based in part on the frequency of word misspellings in prior search activity.

In some implementations, the sophistication metric is based in part on prior question answering 406, corresponding to previously answered questions by a particular user. In some implementations, interactions associated with prior question answering 406 are analyzed based on linguistic characteristics such as those described above, user feedback, the content of previous questions successfully answered, the complexity of questions previously answered, any other suitable characteristics, and any combination thereof. For example, a user that has previously answered highly complex questions may be assigned a high sophistication metric 402. In some implementations, sophistication metric 402 is determined based on the difficulty of prior questions answered, the content of prior answered questions, the content of search query history associated with the question answerer, user defined preferences, the content of other interactions associated with the user, any other suitable content, or any combination thereof.

In some implementations, subject area knowledge 408 is used in determining sophistication metric 402. In some implementations, subject area knowledge 408 corresponds to a user's sophistication in a particular subject area. Subject area knowledge 408 may be based on prior questions answered in that subject area, previous searches related to the subject area, webpages browsed related to the subject area, the amount of time spent viewing content related to a subject area, the type of content related to a subject area, user defined preferences, any other suitable information, or any combination thereof. For example, a user's viewing of academic journal articles may be indicative of a higher level of sophistication in a particular area than a user's viewing of an internet encyclopedia page. In another example, user defined preferences include a user manually specifying particular areas of interest.

In some implementations, multiple sophistication metrics such as sophistication metric 402 are maintained, for example, individual metrics corresponding to particular subject areas may be maintained. In some implementations, sophistication metrics are combined using any suitable technique, for example, a weighted average, to form a combined sophistication metric.

In some implementations, complexity of question 410 is used to determine sophistication metric 402. In an example, the system assigns a high sophistication metric 402 to a moderately knowledgeable question answerer when answering a low complexity question, based on complexity of question 410. In another example, the system need not alter the sophistication metric need based on the question complexity, but rather the system includes the information in generating a metric analysis, as described below in step 312 of FIG. 3.

In some implementations, the system determines sophistication metric 402 in part on sophistication of asker 412. Sophistication of asker 412 corresponds to a sophistication metric determined for the question asker. The system may determine the sophistication of asker 412 using any of the techniques described herein, any other suitable technique, or any combination thereof. In some implementations, the system selects a question answerer with a similar or slightly higher sophistication metric than the question asker. For example, if the question asker has sophistication of asker 412 with value 0.6 on a scale of 0 to 1, the question from that asker may be provided to a question answerer with sophistication metric 402 value of 0.7, that is to say, slightly higher than the sophistication of asker 412. In this way, expert question answerers are not provided with questions from novice users. In some implementations, this allows more question answerers to be involved in question answering, and also allows expert answerers to be available for particularly difficult questions.

In some implementations, sophistication metric 402 is determined based on complexity of question 410. In some implementations, the system determines complexity of question 410. As described above, complexity relates to an expected difficulty of answering the question. The complexity metric represents the complexity of the question received in step 302 of FIG. 3. In some implementations, the system may use the complexity of question 410 to generate, modify, refine, or otherwise determine sophistication metric 402. In an example, a generally sophisticated question answerer may be assigned a low sophistication metric with regards to a highly complex question in a subject area with which the question answerer is not familiar. In another example, a generally less sophisticated question answerer may be assigned a higher sophistication metric 402 if the question is in a particular subject area with which they are familiar.

In some implementations, the system determines complexity of question 410 based at least in part on linguistics 414. Linguistics 414 correspond to linguistic characteristics of the question. Linguistics 414 may include, for example, the number of words in a question, the length of words in the question, the complexity of words in the question, how common the words used in the question are, the syntax of the question, the use of particular punctuation marks and other grammatical constructions. In an example, a longer question may be assigned a high complexity metric, while a short question may be assigned a low complexity metric. In another example, a question that uses uncommon words may be assigned a high complexity metric. The commonality of words may be determined based on previously received questions, indexes of content, for example on the Internet, a previously compiled list, any other suitable technique, or any combination thereof. In another example, a question that includes words that appear very infrequently in other questions received by the system may be assigned a high complexity metric. In some implementations, the system may determine a complexity metric based in part on input from the asker in addition to the question. For example, a question asker may flag a question as being of high or low complexity.

In some implementations, the system determines the complexity of question 410 based in part on the sophistication of asker 412. For example, a question from a user with a high sophistication metric may be assigned a high complexity metric.

In some implementations, complexity of question 410 is determined based on question content 416. For example, question content 416 may include the particular subject area of the question, comparisons to other previously answered questions, other suitable characteristics corresponding to the content of the question received in step 302 of FIG. 3, and any combination thereof.

Referring back to FIG. 3, in step 308, the system determines a willingness metric. As described above, willingness corresponds to an expected willingness of a question answerer to answer a particular question. In some implementations, the willingness metric is a numerical representation of the willingness a question answerer identified in step 304. In an example, if the system expects a potential question answerer to be willing to answer a question, the system assigns the question answerer a high willingness metric. In some implementations, the willingness metric is determined based in part on the question received in step 302. For example, the system may identify keywords or elements in the question that are used in determining the willingness. In a further example, the system may use the question in identifying potential question answerers in step 304, and then determining the willingness based on a relationship between the question answerers and the question.

In some implementations, the system determines a willingness metric based on prior social interactions associated with potential question answerers. In some implementations, the system determines a willingness metric based on an amount of prior social interactions, a type of prior social interactions, a degree of social connectivity associated with those interactions, any other suitable information associated with prior social interactions, and any combination thereof. In some implementations, a type of social interaction corresponds to whether an interaction was by email, phone, social media website, or other interaction format. In some implementations, an amount of social interaction corresponds to a total number or frequency of a particular interaction. For example, a number of social media blog posts.

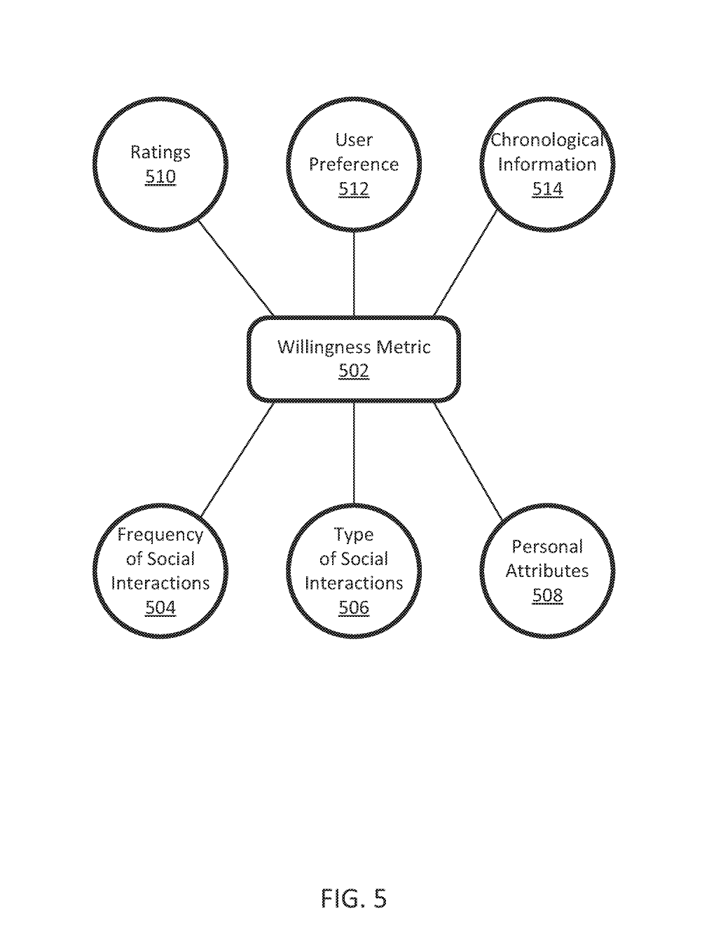

FIG. 5 shows exemplary data used in determining willingness metric 502 in accordance with some implementations of the present disclosure. In some implementations, willingness metric 502 corresponds to the willingness metric determined in step 308 of FIG. 3. As illustrated, one or more data elements are used to determine willingness metric 502.

In some implementations, frequency of social interactions 504 are used in determining willingness metric 502. In some implementations, frequency of social interactions 504 corresponds to how frequently a user interacts with other users, for example, on a social network. In some implementations, type of social interactions 506 are used in determining willingness metric 502. Type of social interaction includes a degree of connectivity, where the social interaction takes place, a length of social interaction, the particular content of social interactions, any other suitable information, or any combination thereof. In some implementations, a degree of social connectivity corresponds to a number of connections separating two users. For example, the degree of social connectivity may be 0 for two users who are directly connected in a social network, a connection sometimes referred to as friends. The degree of connectivity may be 1 for friends-of-friends, 2 for friends-of-friends-of-friends, and so on. In some implementations, users may be strangers, that is, there is no social connectivity between them. It will be understood that this determination of a degree of connectivity is merely exemplary and that the system may use any suitable determination. In an example, a particular potential question answerer may frequently interact with friends and friends-of-friends, and rarely interact with strangers when using social networking sites, emailing, participating in internet forums and chat rooms, in other suitable online activities. In the example, the system may accordingly assign the user a high willingness to answer questions for close social connections and a low willingness for strangers.

In some implementations, personal attributes 508 are used in determining willingness metric 502. In an example, the system may assign a question received in step 302 of FIG. 3 to a question answerer with similar personal attributes as the question asker. In another example, the asker specifically indicates or shows a preference for answerers in previous interactions for a particular personal attribute, such as those close in age to themselves. It will be understood that these interactions may include question answering interactions, social media interactions, any other suitable interactions, and any combination thereof. In another example, the system assigns a higher willingness metric to personal attributes that have shown more success with a particular question type or subject area. In an example, women are more willing to answer questions about haircuts for long hair, while men are more willing to answer questions about beard shaving techniques.

In some implementations, ratings 510 are used in determining willingness metric 502. In some implementations, the ratings 510 are determined in part to remove or reduce the impact of maliciously poor question answerers in the system, sometimes referred to as trolls. As described above, maliciously poor question answerers may be very willing to answer questions, but provide low quality answers and thus are undesirable in a question answering system. In some implementations, the system receives feedback from askers following question answering interactions, where the askers rate the question answerer. The ratings may include numerical feedback such as a rating on a scale of 1-10, a star rating such as between 1 and 4 star, text comments, a good or bad rating, any other suitable rating, or any combination thereof. Ratings 510 may be based on the quality of the answer, accuracy, timeliness, language, readability, grammar, politeness, any other suitable quality, or any combination thereof. It will be understood that the rating system may, in addition to identifying maliciously poor question answerer, also identify other undesirable answerers such as benevolently poor answerers, slow question answerers, and answerers with poor language skills.

In some implementations, user preferences 512 are used in determining willingness metric 502. For example, user preferences 512 may include preferences set by potential question answerers. For example, question answerers may indicate that they are more or less willing to answer questions about a particular topic, more or less willing to answer questions at a particular time of day, more or less willing to answer questions from particular askers or groups of askers, more or less willing based on any other suitable criteria, and any combination thereof.

In some implementations, chronological information 514 is used in determining willingness metric 502. Chronological information 514 includes time of day, date, day of the week, any other suitable time-related information, and any combination thereof. For example, the system may retrieve information regarding the times of day during which a potential question answerer has previously answered one or more questions, and assign a higher willingness metric during those times and a low willingness metric during other times.

Referring back to FIG. 3, in step 310, the system determines a busyness metric. As described above, the busyness metric corresponds to the availability of a user at that time.

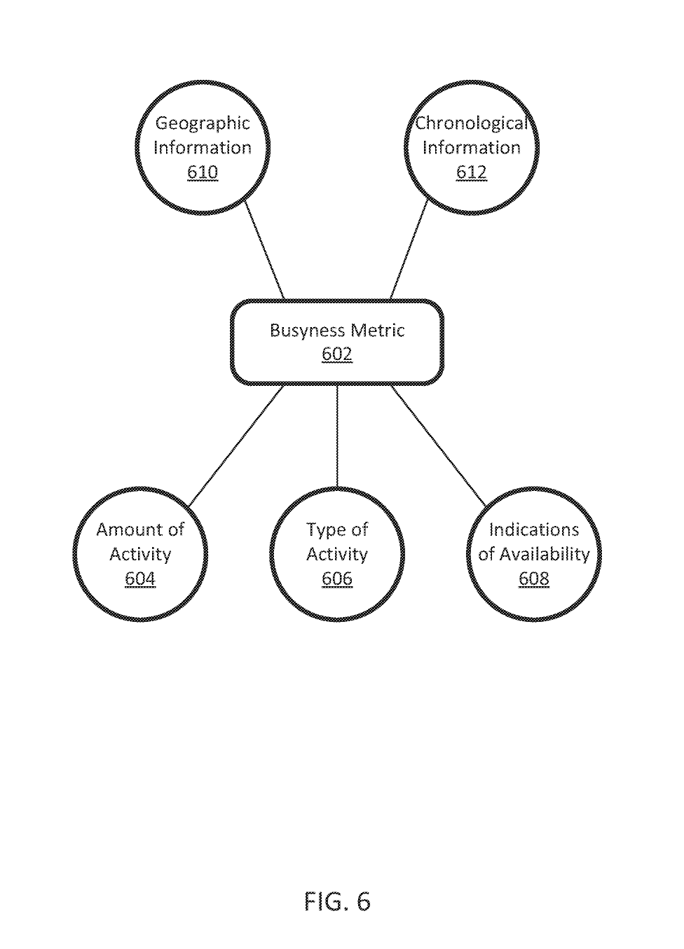

FIG. 6 shows exemplary data used in determining busyness metric 602 in accordance with some implementations of the present disclosure. In some implementations, busyness metric 602 corresponds to the busyness metric determined in step 310 of FIG. 3. As illustrated, one or more data elements are used to determine busyness metric 602.

In some implementations, the system determines busyness metric 602 based in part on activity of a question answerer. For example, how actively engaged in computer activities a user is at the time of selecting a question answerer. In some implementations, determinations of activity include amount of activity 604 and type of activity 606. Amount of activity 604 includes any suitable measure of the volume of activity associated with a user. For example, a number of emails per hour, the rate of composition of a word document, a number of page downloads, a number of internet searches, any other suitable information, or any combination thereof. Type of activity 606 may include, for example, an application in use, the number of applications running, a website being viewed, the number of websites being viewed, how long a particular user views a webpage, an amount of keystrokes or other input, any other suitable information, or any combination thereof. In an example, the system determines that a user is composing a text document using a word processor, and accordingly assigns the user a high busyness metric. In another example, the system may determine that the user is browsing webpages for relatively short amounts of time per page, and accordingly assigns the user a low busyness metric.

In some implementations, indications of availability 608 are used in determining busyness metric 602. Indications of availability 608 may include indications of availability received from a potential question answerer. For example, a question answerer may set their availability by indicating to the system that they do not want to answer questions at that particular time, and would accordingly be assigned a high busyness metric. In another example, a question answerer may indicate that they are moderately busy or not busy, and the system may set the busyness metrics correspondingly.

In some implementations, geographic information 610 is used in determining busyness metric 602. Geographic information may include any suitable geographic information that a user has elected to provide to the system. In an example, the time zone of a user is determined based on geographical information 610, and busyness metric 602 is determined based on that time zone. In another example, a user may indicate that they only want to receive questions when they are within a particular distance from their home location, and not when they are at their work location. In another example, if a user is rapidly moving in location, it may be assumed that they are in a car and are not available to answer questions. In some implementations, geographical information may be determined using a global positioning system, wireless network information, cellular network information, using any other suitable technique, or any combination thereof.

In some implementations, chronological information 612 is used in determining busyness metric 602. Chronological information 612 includes time of day, date, day of the week, any other suitable time-related information, and any combination thereof. In an example, the system may determine that a potential question answerer is more busy during the day and less busy at night, and thus would determine a lower busyness metric 602 at night. In another example, the system may determine that a potential question answerer is less busy during the weekend.

Referring back to FIG. 3, in step 312, the system generates a metric analysis. In some implementations, generating a metric analysis includes one or more of the sophistication metric determined in step 306, the willingness metric determined in step 308, and the busyness metric determined in step 310. In some implementations, the metric analysis includes combining, comparing, weighting, adding, subtracting, dividing, neural networks, artificial intelligence, adaptive processing, other algorithms, any other suitable analysis, or any combination thereof. In an example, the system generates a combined metric that accords the highest ranking to the potential question answerer with the highest sophistication, the highest willingness, and the lowest busyness metrics. In another example, the metric analysis only considers the sophistication metric. It will be understood that the particular type of metric analysis may be selected and generated based on question answerer settings, question asker settings, system design, prior question answering interactions, any other suitable parameters, or any combination thereof.

In some implementations, the system generating a metric analysis includes multiplying the metrics together. In this implementation, each metric will alter the other metrics in determining a combined metric. For example, if one of the metrics is relatively weak and another metric is relatively strong, the product of their multiplication will be moderated by the weak metric. In an example, this multiplication may rank a busy but highly sophisticated question answerer lower than a less busy but less sophisticated answerer. In some implementations, the system applies weights to the metrics before multiplying them together, such that some signals are given more importance than others. In some implementations, the system may use cutoff values for particular metrics. For example, busyness metrics above a certain value may be replaced with a 0 value, such that busy answerers will not be selected as question answerers, despite particularly high willingness or sophistication metrics. It will be understood that the aforementioned techniques for combining metrics are merely exemplary and that any suitable techniques may be used.

In some implementations, the metric analysis includes determining a relationship between the complexity metric of a question and the sophistication metric of a question answerer. For example, it may be desirable to provide answerers with questions that the system expects they will be able to answer successfully based on the relationship. Further, question answerers need not be provided with questions that are overly simple in view of the relationship. In this way, highly sophisticated question answerers remain engaged in participation by receiving challenging or interesting questions, while less sophisticated question answerers are also able to participate by receiving questions of an appropriate difficulty level. In some implementations, the use of a relationship between question complexity and answerer sophistication may result in a higher overall participation and satisfaction level of users. This may, for example, lead to more willingness for future interactions on the part of all users.

In step 314, the system selects a question answerer. In some implementations, the system selects a question answerer based in part on the metric analysis of step 312. In an example where potential question answerers are accorded a combined metric in the metric analysis of step 312, the system may select the question answerer with the highest combined metric.

In step 316, the system provides the question to the selected question answerer. In some implementations, the question received in step 302 is provided to the question answerer selected in step 314. In an example, the question is provided as a text question in an Internet browser window, is provided using a smartphone application, is provided using a tablet computer application, is provided using a voice phone call, is provided by email, is provided using any other suitable technique, or any combination thereof. In some implementations, the question is provided as shown in question providing block 230 of FIG. 2 and selected answerer block 108 of FIG. 1.

In step 318, the system receives a response from the selected question answerer. In some implementations, the response corresponds to the question provided to the question answerer in step 316. In some implementations, the response is received using the same or a similar interface through which the question was provided in step 316. In some implementations, the answer is received as a text response, an audio response, a video response, a response in any other suitable format, or any combination thereof. In some implementations, responses include words, images, links, documents, any other suitable content, or any combination thereof. In some implementations, the response includes an indication that the question answerer does not know the answer. In some implementations, the response includes an indication that the question answerer is not available or does not choose to answer the question. In some implementations, the response corresponds to the response received in response entry box 234 of FIG. 2.

In step 320, the system provides an answer to the question asker. In some implementations, the answer is based in part on the response received the selected question answerer in step 318. In some implementations, the response is provided as shown in answer providing block 240. In some implementations, the system provides the answer as the text received from the question answerer in step 318. In some implementations, the system provides an answer based on the text of the response received. For example, in response to the question [What is the largest city in Japan] the system may receive the response [Tokyo] in step 318 and provide the answer [The largest city in Japan is Tokyo] in step 320. In another example, the system may convert an audio response to text, and provide that text to the question asker. In another example, the system may translate between languages before providing an answer to the question asker. It will be understood that the aforementioned are merely exemplary, and that the system may generate an answer to provide to the question asker using any suitable technique.

In some implementations, the system provides rewards to users. In some implementations, rewards are provided to the question answerer after providing response to a question as a form of positive feedback to encourage further participation. In some implementations, rewards are provided after receiving the response in step 318, after providing the answer to the asker in step 320, after receiving confirmation or feedback from the question asker, at any other suitable time, or any combination thereof. For example, the asker may indicate that they are satisfied with the answer, and the system may then provide a reward to the question answerer. In another example, the asker may rate the answer on a rating scale, and the question answerer may receive a reward based on that rating. Rewards may include a point system, the opportunity for further participation in the system, a status level in the system, any other suitable rewards, or any combination thereof. In an example, after successfully answering a particular number of questions, a question answerer may receive a badge indicating that they are a trusted question answerer. In some implementations, the ratings and/or feedback used for rewards are the same or similar to those used to identify maliciously poor question answerers with regard to the willingness metric in step 308.

It will be understood that the steps above are exemplary and that in some implementations, steps may be added, removed, omitted, repeated, reordered, modified in any other suitable way, or any combination thereof.

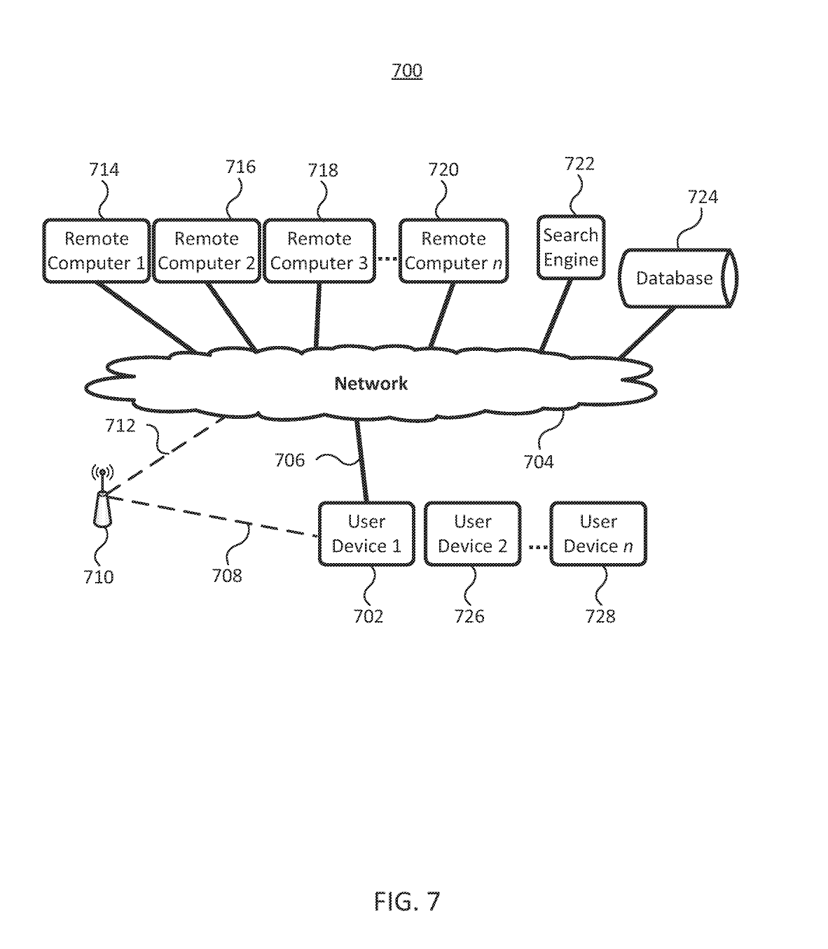

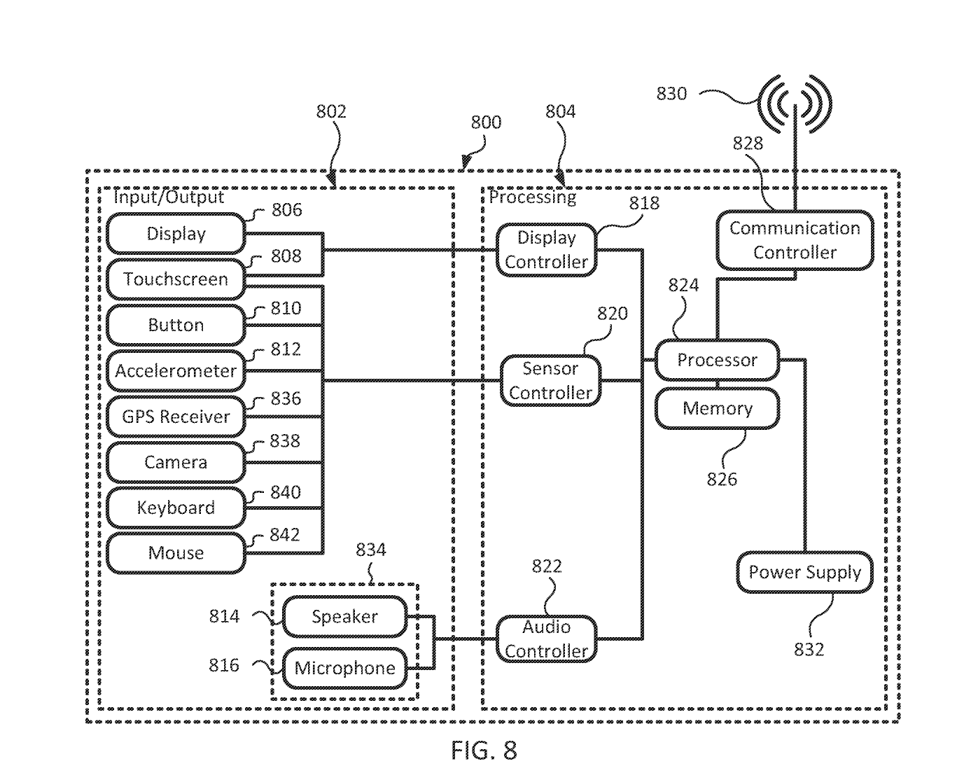

The following description and accompanying FIGS. 7 and 8 describe illustrative computer systems that may be used in some implementations of the present disclosure. It will be understood that elements of FIGS. 7 and 8 are merely exemplary and that any suitable elements may be added, removed, duplicated, replaced, or otherwise modified.

It will be understood that the system may be implemented on any suitable computer or combination of computers. In some implementations, the system is implemented in a distributed computer system including two or more computers. In an example, the system may use a cluster of computers located in one or more locations to perform processing and storage associated with the system. It will be understood that distributed computing may include any suitable parallel computing, distributed computing, network hardware, network software, centralized control, decentralized control, any other suitable implementations, or any combination thereof.

FIG. 7 shows an illustrative computer system in accordance with some implementations of the present disclosure. System 700 may include any suitable number of user devices, including user device 702, user device 726, and user device 726. It will be understood that characteristics of user device 702 described herein may relate to any one or more user devices. In some implementations, user device 702, and any other device of system 700, includes one or more computers and/or one or more processors. In some implementations, a processor includes one or more hardware processors, for example, integrated circuits, one or more software modules, computer-readable media such as memory, firmware, or any combination thereof. In some implementations, user device 702 includes one or more computer-readable medium storing software, include instructions for execution by the one or more processors for performing the techniques discussed above with respect to FIG. 3, or any other techniques disclosed herein. In some implementations, user device 702 includes a smartphone, tablet computer, desktop computer, laptop computer, server, personal digital assistant, portable audio player, portable video player, mobile gaming device, other suitable user device capable of providing content, or any combination thereof.

User device 702 may be coupled to network 704 directly through connection 706, through wireless repeater 710, by any other suitable way of coupling to network 704, or by any combination thereof. Network 704 may include the Internet, a dispersed network of computers and servers, a local network, a public intranet, a private intranet, other coupled computing systems, or any combination thereof.

User device 702 may be coupled to network 704 by wired connection 706. Connection 706 may include Ethernet hardware, coaxial cable hardware, DSL hardware, T-1 hardware, fiber optic hardware, analog phone line hardware, any other suitable wired hardware capable of communicating, or any combination thereof. Connection 706 may include transmission techniques including TCP/IP transmission techniques, IEEE 802 transmission techniques, Ethernet transmission techniques, DSL transmission techniques, fiber optic transmission techniques, ITU-T transmission techniques, any other suitable transmission techniques, or any combination thereof.

User device 702 may be wirelessly coupled to network 704 by wireless connection 708. In some implementations, wireless repeater 710 receives transmitted information from user device 702 by wireless connection 708 and communicates it with network 704 by connection 712. Wireless repeater 710 receives information from network 704 by connection 712 and communicates it with user device 702 by wireless connection 708. In some implementations, wireless connection 708 may include cellular phone transmission techniques, code division multiple access transmission techniques, global system for mobile communications transmission techniques, general packet radio service transmission techniques, satellite transmission techniques, infrared transmission techniques, Bluetooth transmission techniques, Wi-Fi transmission techniques, WiMax transmission techniques, any other suitable transmission techniques, or any combination thereof.

Connection 712 may include Ethernet hardware, coaxial cable hardware, DSL hardware, T-1 hardware, fiber optic hardware, analog phone line hardware, wireless hardware, any other suitable hardware capable of communicating, or any combination thereof. Connection 712 may include wired transmission techniques including TCP/IP transmission techniques, IEEE 802 transmission techniques, Ethernet transmission techniques, DSL transmission techniques, fiber optic transmission techniques, ITU-T transmission techniques, any other suitable transmission techniques, or any combination thereof. Connection 712 may include may include wireless transmission techniques including cellular phone transmission techniques, code division multiple access transmission techniques, global system for mobile communications transmission techniques, general packet radio service transmission techniques, satellite transmission techniques, infrared transmission techniques, Bluetooth transmission techniques, Wi-Fi transmission techniques, WiMax transmission techniques, any other suitable transmission techniques, or any combination thereof.

Wireless repeater 710 may include any number of cellular phone transceivers, network routers, network switches, communication satellites, other devices for communicating information from user device 702 to network 704, or any combination thereof. It will be understood that the arrangement of connection 706, wireless connection 708 and connection 712 is merely illustrative and that system 700 may include any suitable number of any suitable devices coupling user device 702 to network 704. It will also be understood that any user device 702, may be communicatively coupled with any user device, remote server, local server, any other suitable processing equipment, or any combination thereof, and may be coupled using any suitable technique as described above.

In some implementations, any suitable number of remote servers 714, 716, 718, 720, may be coupled to network 704. Remote servers may be general purpose, specific, or any combination thereof. One or more search engine servers 722 may be coupled to the network 704. In some implementations, search engine server 722 may include a data graph such as the social graph and/or any other suitable content of content 106 of FIG. 1, may include processing equipment configured to access a data graph, may include processing equipment configured to receive search queries related to a data graph, may include any other suitable information or equipment, or any combination thereof. One or more database servers 724 may be coupled to network 704. In some implementations, database server 724 may store a data graph such as the social graph or any other suitable content of content 106 of FIG. 1. In some implementations, where there is more than one data graph, the more than one graph may be included in database server 724, may be distributed across any suitable number of database servers and general purpose servers by any suitable technique, or any combination thereof. It will also be understood that the system may use any suitable number of general purpose, specific purpose, storage, processing, search, any other suitable server, or any combination.

FIG. 8 is a block diagram of a device of system 700 of FIG. 7 in accordance with some implementations of the present disclosure. FIG. 8 includes computing device 800. In some implementations, computing device 800 corresponds to user device 702 of FIG. 7, a remote computer illustrated in system 700 of FIG. 7, any other suitable computer corresponding to system 700 of FIG. 7, any other suitable device, or any combination thereof. In some implementations, computing device 800 is an illustrative local and/or remote computer that is part of a distributed computing system. Computing device 800 may include input/output equipment 802 and processing equipment 804. Input/output equipment 802 may include display 806, touchscreen 808, button 810, accelerometer 812, global positions system receiver 836, camera 838, keyboard 840, mouse 842, and audio equipment 834 including speaker 814 and microphone 816. In some implementations, the equipment of computing device 800 may be representative of equipment included in a smartphone user device. It will be understood that the specific equipment included in the illustrative computer system may depend on the type of user device. For example, the input/output equipment 802 of a desktop computer may include a keyboard 840 and mouse 842 and may omit accelerometer 812 and GPS receiver 836. It will be understood that computing device 800 may omit any suitable illustrated elements, and may include equipment not shown such as media drives, data storage, communication devices, display devices, processing equipment, any other suitable equipment, or any combination thereof.

In some implementations, display 806 may include a liquid crystal display, light emitting diode display, organic light emitting diode display, amorphous organic light emitting diode display, plasma display, cathode ray tube display, projector display, any other suitable type of display capable of displaying content, or any combination thereof. Display 806 may be controlled by display controller 818 or by processor 824 in processing equipment 804, by processing equipment internal to display 806, by other controlling equipment, or by any combination thereof. In some implementations, display 806 may display data from a social graph.

Touchscreen 808 may include a sensor capable of sensing pressure input, capacitance input, resistance input, piezoelectric input, optical input, acoustic input, any other suitable input, or any combination thereof. Touchscreen 808 may be capable of receiving touch-based gestures. Received gestures may include information relating to one or more locations on the surface of touchscreen 808, pressure of the gesture, speed of the gesture, duration of the gesture, direction of paths traced on its surface by the gesture, motion of the device in relation to the gesture, other suitable information regarding a gesture, or any combination thereof. In some implementations, touchscreen 808 may be optically transparent and located above or below display 806. Touchscreen 808 may be coupled to and controlled by display controller 818, sensor controller 820, processor 824, any other suitable controller, or any combination thereof. In some implementations, touchscreen 808 may include a virtual keyboard capable of receiving, for example, a search query used to identify data in a data graph.

In some embodiments, a gesture received by touchscreen 808 may cause a corresponding display element to be displayed substantially concurrently, for example, immediately following or with a short delay, by display 806. For example, when the gesture is a movement of a finger or stylus along the surface of touchscreen 808, the search system may cause a visible line of any suitable thickness, color, or pattern indicating the path of the gesture to be displayed on display 806. In some implementations, for example, a desktop computer using a mouse, the functions of the touchscreen may be fully or partially replaced using a mouse pointer displayed on the display screen.

Button 810 may be one or more electromechanical push-button mechanism, slide mechanism, switch mechanism, rocker mechanism, toggle mechanism, other suitable mechanism, or any combination thereof. Button 810 may be included in touchscreen 808 as a predefined region of the touchscreen, for example, soft keys. Button 810 may be included in touchscreen 808 as a region of the touchscreen defined by the search system and indicated by display 806. Activation of button 810 may send a signal to sensor controller 820, processor 824, display controller 820, any other suitable processing equipment, or any combination thereof. Activation of button 810 may include receiving from the user a pushing gesture, sliding gesture, touching gesture, pressing gesture, time-based gesture, for example, based on the duration of a push, any other suitable gesture, or any combination thereof.

Accelerometer 812 may be capable of receiving information about the motion characteristics, acceleration characteristics, orientation characteristics, inclination characteristics and other suitable characteristics, or any combination thereof, of computing device 800. Accelerometer 812 may be a mechanical device, microelectromechanical device, nanoelectromechanical device, solid state device, any other suitable sensing device, or any combination thereof. In some implementations, accelerometer 812 may be a 3-axis piezoelectric microelectromechanical integrated circuit which is configured to sense acceleration, orientation, or other suitable characteristics by sensing a change in the capacitance of an internal structure. Accelerometer 812 may be coupled to touchscreen 808 such that information received by accelerometer 812 with respect to a gesture is used at least in part by processing equipment 804 to interpret the gesture.

Global positioning system receiver 836 may be capable of receiving signals from global positioning satellites. In some implementations, GPS receiver 836 may receive information from one or more satellites orbiting the earth, the information including time, orbit, and other information related to the satellite. This information may be used to calculate the location of computing device 800 on the surface of the earth. GPS receiver 836 may include a barometer, not shown, to improve the accuracy of the location. GPS receiver 836 may receive information from other wired and wireless communication sources regarding the location of computing device 800. For example, the identity and location of nearby cellular phone towers may be used in place of, or in addition to, GPS data to determine the location of computing device 800.

Camera 838 may include one or more sensors to detect light. In some implementations, camera 838 may receive video images, still images, or both. Camera 838 may include a charged coupled device sensor, a complementary metal oxide semiconductor sensor, a photocell sensor, an IR sensor, any other suitable sensor, or any combination thereof. In some implementations, camera 838 may include a device capable of generating light to illuminate a subject, for example, an LED light. Camera 838 may communicate information captured by the one or more sensor to sensor controller 820, to processor 824, to any other suitable equipment, or any combination thereof. Camera 838 may include lenses, filters, and other suitable optical equipment. It will be understood that computing device 800 may include any suitable number of camera 838.

Audio equipment 834 may include sensors and processing equipment for receiving and transmitting information using acoustic or pressure waves. Speaker 814 may include equipment to produce acoustic waves in response to a signal. In some implementations, speaker 814 may include an electroacoustic transducer wherein an electromagnet is coupled to a diaphragm to produce acoustic waves in response to an electrical signal. Microphone 816 may include electroacoustic equipment to convert acoustic signals into electrical signals. In some implementations, a condenser-type microphone may use a diaphragm as a portion of a capacitor such that acoustic waves induce a capacitance change in the device, which may be used as an input signal by computing device 800.

Speaker 814 and microphone 816 may be contained within computing device 800, may be remote devices coupled to computing device 800 by any suitable wired or wireless connection, or any combination thereof.

Speaker 814 and microphone 816 of audio equipment 834 may be coupled to audio controller 822 in processing equipment 804. This controller may send and receive signals from audio equipment 834 and perform pre-processing and filtering steps before transmitting signals related to the input signals to processor 824. Speaker 814 and microphone 816 may be coupled directly to processor 824. Connections from audio equipment 834 to processing equipment 804 may be wired, wireless, other suitable arrangements for communicating information, or any combination thereof.

Processing equipment 804 of computing device 800 may include display controller 818, sensor controller 820, audio controller 822, processor 824, memory 826, communication controller 828, and power supply 832.

Processor 824 may include circuitry to interpret signals input to computing device 800 from, for example, touchscreen 808 and microphone 816. Processor 824 may include circuitry to control the output to display 806 and speaker 814. Processor 824 may include circuitry to carry out instructions of a computer program. In some implementations, processor 824 may be an integrated electronic circuit based, capable of carrying out the instructions of a computer program and include a plurality of inputs and outputs.

Processor 824 may be coupled to memory 826. Memory 826 may include random access memory, flash memory, programmable read only memory, erasable programmable read only memory, magnetic hard disk drives, magnetic tape cassettes, magnetic floppy disks optical CD-ROM discs, CD-R discs, CD-RW discs, DVD discs, DVD+R discs, DVD-R discs, any other suitable storage medium, or any combination thereof.

The functions of display controller 818, sensor controller 820, and audio controller 822, as have been described above, may be fully or partially implemented as discrete components in computing device 800, fully or partially integrated into processor 824, combined in part or in full into combined control units, or any combination thereof.

Communication controller 828 may be coupled to processor 824 of computing device 800. In some implementations, communication controller 828 may communicate radio frequency signals using antenna 830. In some implementations, communication controller 828 may communicate signals using a wired connection, not shown. Wired and wireless communications communicated by communication controller 828 may use Ethernet, amplitude modulation, frequency modulation, bitstream, code division multiple access, global system for mobile communications, general packet radio service, satellite, infrared, Bluetooth, Wi-Fi, WiMax, any other suitable communication configuration, or any combination thereof. The functions of communication controller 828 may be fully or partially implemented as a discrete component in computing device 800, may be fully or partially included in processor 824, or any combination thereof. In some implementations, communication controller 828 may communicate with a network such as network 704 of FIG. 7 and may receive information from a data graph stored, for example, in database 724 of FIG. 7.

Power supply 832 may be coupled to processor 824 and to other components of computing device 800. Power supply 832 may include a lithium-polymer battery, lithium-ion battery, NiMH battery, alkaline battery, lead-acid battery, fuel cell, solar panel, thermoelectric generator, any other suitable power source, or any combination thereof. Power supply 832 may include a hard wired connection to an electrical power source, and may include electrical equipment to convert the voltage, frequency, and phase of the electrical power source input to suitable power for computing device 800. In some implementations of power supply 832, a wall outlet may provide 720 volts, 60 Hz alternating current. A circuit of transformers, resistors, inductors, capacitors, transistors, and other suitable electronic components included in power supply 832 may convert the 720V AC from a wall outlet power to 5 volts at 0 Hz direct current. In some implementations of power supply 832, a lithium-ion battery including a lithium metal oxide-based cathode and graphite-based anode may supply 3.7V to the components of computing device 800. Power supply 832 may be fully or partially integrated into computing device 800, or may function as a stand-alone device. Power supply 832 may power computing device 800 directly, may power computing device 800 by charging a battery, may provide power by any other suitable way, or any combination thereof.

The foregoing is merely illustrative of the principles of this disclosure and various modifications may be made by those skilled in the art without departing from the scope of this disclosure. The above described implementations are presented for purposes of illustration and not of limitation. The present disclosure also may take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

1. A computer-implemented method comprising:
receiving an unanswered question from a question asker;
determining, by at least one processor, a complexity metric associated with the unanswered question based on an attribute of at least one of the question or the question asker;
identifying one or more potential question answerers to answer the unanswered question;
for each of the one or more potential question answerers, determining a sophistication metric;
analyzing, by at least one processor, at least the sophistication metric and the complexity metric to generate a metric analysis; and
selecting, by at least one processor, a question answerer to answer the unanswered question from the potential question answerers based at least in part on the metric analysis.

2. The method of claim 1 further comprising:
providing the unanswered question to the selected question answerer;
receiving an answer corresponding to the unanswered question from the selected question answerer; and
providing the answer to the question asker.

3. The method of claim 1, wherein identifying the one or more potential question answerers comprises identifying the one or more potential question answerers based at least in part on the unanswered question.

4. The method of claim 1, wherein determining the complexity metric comprises determining a complexity metric based at least in part on linguistic characteristics of the unanswered question.

5. The method of claim 1, wherein determining the complexity metric comprises determining the complexity metric based at least in part on a sophistication metric associated with the question asker.

6. The method of claim 1, wherein determining the sophistication metric comprises determining the sophistication metric based at least in part on prior question answering interactions of a respective potential question answerer.

7. The method of claim 1, wherein determining the sophistication metric comprises determining the sophistication metric based at least in part on prior search activity of a respective potential question answerer.

8. The method of claim 1, wherein determining the sophistication metric comprises determining the sophistication metric based at least in part on a knowledge level of a respective potential question answerer in a subject area relevant to the unanswered question.

9. The method of claim 1, wherein identifying one or more potential question answerers comprises identifying the potential question answerers from a social graph.

10. The method of claim 1, further comprising, for each of the one or more potential question answerers, determining a busyness metric associated with the respective potential question answerer, wherein the metric analysis is further generated based on an analysis of the busyness metric.

11. The method of claim 1, further comprising, for each of the one or more potential question answerers, determining a willingness metric associated with the respective potential question answerer, wherein the metric analysis is further generated based on an analysis of the willingness metric.

12. A system comprising:
a storage medium that stores instructions;
one or more computers configured to execute the instructions and perform operations comprising:
receiving an unanswered question from a question asker;
determining a complexity metric associated with the unanswered question based on an attribute of at least one of the question or the question asker;
identifying one or more potential question answerers to answer the unanswered question;
for each of the one or more potential question answerers, determining a sophistication metric;
analyzing at least the sophistication metric and the complexity metric to generate a metric analysis; and
selecting a question answerer to answer the unanswered question from the potential question answerers based at least in part on the metric analysis.

13. The system of claim 12, wherein the one or more computers are configured to perform operations further comprising:
providing the unanswered question to the selected question answerer;
receiving an answer corresponding to the unanswered question from the selected question answerer; and
providing the answer to the question asker.

14. The system of claim 12, wherein identifying the one or more potential question answerers comprises identifying the one or more potential question answerers based at least in part on the unanswered question.

15. The system of claim 12, wherein determining the complexity metric comprises determining a complexity metric based at least in part on linguistic characteristics of the unanswered question.

16. The system of claim 12, wherein determining the complexity metric comprises determining the complexity metric based at least in part on a sophistication metric associated with the question asker.

17. The system of claim 12, wherein determining the sophistication metric comprises determining the sophistication metric based at least in part on prior question answering interactions of a respective potential question answerer.

18. The system of claim 12, wherein determining the sophistication metric comprises determining the sophistication metric based at least in part on prior search activity of a respective potential question answerer.

19. The system of claim 12, wherein determining the sophistication metric comprises determining the sophistication metric based at least in part on a knowledge level of a respective potential question answerer in a subject area relevant to the unanswered question.

20. The system of claim 12, wherein identifying one or more potential question answerers comprises identifying the potential question answerers from a social graph.

21. The system of claim 12, wherein the one or more computers are configured to perform operations further comprising:
for each of the one or more potential question answerers, determining a busyness metric associated with the respective potential question answerer, wherein the metric analysis is further generated based on an analysis of the busyness metric.

22. The system of claim 12, wherein the one or more computers are configured to perform operations further comprising:
for each of the one or more potential question answerers, determining a willingness metric associated with the respective potential question answerer, wherein the metric analysis is further generated based on an analysis of the willingness metric.

23-66. (canceled)
